(19) United States
(12) Patent Application Publication
(10) Pub. No.: US 2014/0311338 A1
(43) Pub. Date: Oct. 23, 2014

(54) Hydraulic Actuator

(71) Applicant: Portway Design LLP, Salisbury (GB)

(72) Inventor: John Gerard Foster, Salisbury (GB)

(73) Assignee: PORTWAY DESIGN LLP, Salisbury (GB)

(21) Appl. No.: 14/358,565

(22) PCT Filed: Oct. 31, 2012
(86) PCT No.: PCT/GB2012/052718

§ 371 Date: May 15, 2014

(30) Foreign Application Priority Data
Nov. 16, 2011 (GB) 1119776.1

(51) Int. Cl. F15B 15/00

(52) U.S. Cl. CPC F15B 15/00
USPC 92/172

(57) ABSTRACT

A hydraulic actuator with a minimal closed height includes a housing (11), a chamber (12), and a fluid inlet (13) formed within the housing and arranged for communicating high pressure fluid to the chamber (12), the chamber (12) being partially divided into an inner portion (P1) and a radially outer portion (P2) by a longitudinally extending sleeve (123) having an open end (1231) proximal to a base (121) of the chamber (12) and spaced apart therefrom, the outer portion (P2) being arranged to communicate high pressure fluid from the fluid inlet(13) to the inner portion (P1) through a space (S) defined between the end (1231) of the sleeve (123) and the base (121), and the inner portion (P1) being adapted to receive a piston (100) such that the piston (100) is slidably actuable in dependence on the high pressure fluid received from the outer portion (P2).

### RELATED APPLICATION DATA

This application is a continuation of and claims priority under 35 U.S.C. §371 to International Application No. PCT/GB12/52718 filed on Oct. 31, 2013, which in turn claims priority to GB 11161718.9 filed on Nov. 16, 2011. The contents of both these applications are incorporated herein by reference for all purposes.

### BACKGROUND OF THE INVENTION

### Field of the Invention

This invention relates to a hydraulic actuator, and particularly but not exclusively a hydraulic jack.

It is known to use a hydraulic actuator to raise and lower an object, particularly a heavy object. Typically a hydraulic actuator comprises a cylinder and a fluid inlet, the cylinder being adapted to receive a piston and the fluid inlet being arranged to communicate high pressure hydraulic fluid to the interior of the cylinder. In use, the pressure of the hydraulic fluid within the cylinder forces the piston upwardly as the amount of hydraulic fluid in the cylinder is increased. The piston may also move downwardly under gravity or vacuum suction if the amount of hydraulic fluid in the cylinder is reduced.

The fluid inlet of a known type of hydraulic actuator is disposed at the base of the cylinder and depends downwardly therefrom. One problem with a hydraulic actuator of this type is that the downwardly depending portion of fluid inlet contributes to the total height of the hydraulic actuator. This is a particular problem if the hydraulic actuator is used in applications requiring a minimal ‘closed height’ (defined as the height of the actuator when the piston is disposed at the base of the cylinder) such as hospital beds and car jacks. It will also be appreciated that the vertical space associated with the downwardly depending portion of fluid inlet is essentially wasted space i.e. the piston is unable to move in this space. As such, it would be desirable to eliminate this wasted space.

The fluid inlet of a second known type of hydraulic actuator is disposed in the side wall of the cylinder. However, the fluid inlet must abut the base of the cylinder in order to communicate fluid to the entire length of the cylinder. It will be appreciated that the interior of the fluid inlet must have a height large enough to be machined and to allow sufficient hydraulic fluid to pass therethrough. Furthermore, the fluid inlet must have a lower wall of sufficient thickness to withstand the high pressure of the hydraulic fluid contained therein. The thickness of the lower wall and the height of the interior of the fluid inlet both contribute to the closed height of the actuator.

### SUMMARY OF THE INVENTION

I have now devised a new type of hydraulic actuator with a reduced closed height compared to the two above-mentioned types of hydraulic actuator.

In accordance with the present invention there is provided a hydraulic actuator comprising a housing, a chamber disposed within the housing, and a fluid inlet formed within the housing arranged for communicating hydraulic fluid to the chamber, wherein the chamber comprises a base, a tubular side wall and a sleeve having an open end proximal to the base and spaced apart therefrom, the sleeve being arranged to divide the chamber into an inner portion and a radially outer portion, the outer portion being arranged to communicate high pressure fluid from the fluid inlet to the inner portion through a space defined between the end of the sleeve and the base, and the inner portion being adapted to receive a piston such that the piston is slidably actuable in dependence on the high pressure fluid received from the outer portion.

Advantageously, the closed height of the actuator is independent of the position of the fluid inlet and the interior height of the fluid inlet. Therefore the fluid inlet may be disposed a significant distance from the base of the chamber without any adverse effects on the closed height, thereby ensuring that a lower wall of the fluid inlet is sufficiently thick to withstand the pressure of the fluid. Furthermore, the interior height of the fluid inlet may be large enough to be machined and to allow sufficient hydraulic fluid to pass therethrough.

Preferably the open end of the sleeve is disposed longitudinally intermediate the fluid inlet and the base i.e. the fluid inlet is disposed above the open end of the sleeve, the upwardly direction being defined as the direction in which the chamber extends from the base. In use, fluid entering the radially outer portion from the fluid inlet flows downwardly towards the base, the flow path being partially bounded by an outer face of the sleeve. Once the fluid arrives at the end of the sleeve it may pass into the inner portion through the space defined between the end of the sleeve and into the inner portion.

Preferably an outer face of the sleeve abuts the housing above the fluid inlet and is spatially separated from the housing below the fluid inlet. As such, the outer portion of the chamber terminates above the fluid inlet.

Preferably an exterior face of the sleeve is sealingly attached to the housing by attachment means, the attachment being preferably disposed above the fluid inlet in order to enable fluid communication between the fluid inlet and the outer portion.

Preferably the attachment means is disposed immediately above the fluid inlet. In this preferable embodiment the attachment means defines an upper end to the outer portion and thus any fluid that enters the outer portion is prevented from flowing upwardly.

Preferably the attachment means comprises a first threaded member disposed on the housing and a second threaded member disposed on the exterior face of the sleeve, the second threaded member being arranged for cooperation with the first threaded member.

Preferably the sleeve is tubular.

Preferably a longitudinal axis of the sleeve is substantially parallel to a longitudinal axis of the tubular side wall.

Preferably the sleeve is concentric with the tubular side wall such that the inner portion of the chamber is bounded by an interior face of the sleeve and the outer portion of the chamber is bounded by the exterior face of the sleeve and a tubular side wall.

Preferably the inner portion is substantially circular in cross-section.

Preferably the outer portion is substantially annular in cross-section.

Preferably the inner portion extends upwardly further from the base of the chamber than the outer portion.

Preferably the base of the chamber is formed integrally with the housing.

Preferably the tubular side wall of the chamber is formed integrally with the housing.

### BRIEF DESCRIPTION OF THE DRAWINGS

An embodiment of the present invention will now be described by way of example only and with reference to the accompanying drawings, in which:

FIG. 1 is a cut-away perspective view of a hydraulic actuator in accordance with a first embodiment the present invention;

FIG. 2 is a sectional view of the hydraulic actuator illustrated in FIG. 1 taken along the plane A-A;

FIG. 3 is a sectional view of the hydraulic actuator illustrated in FIG. 1 taken along the plane B-B;

FIG. 4 is a cut-away perspective view of a hydraulic actuator in accordance with a second embodiment the present invention; and,

FIG. 5 is a cut-away perspective view of a hydraulic actuator in accordance with a third embodiment the present invention.

### DETAILED DESCRIPTION OF THE PREFERRED EMBODIMENT

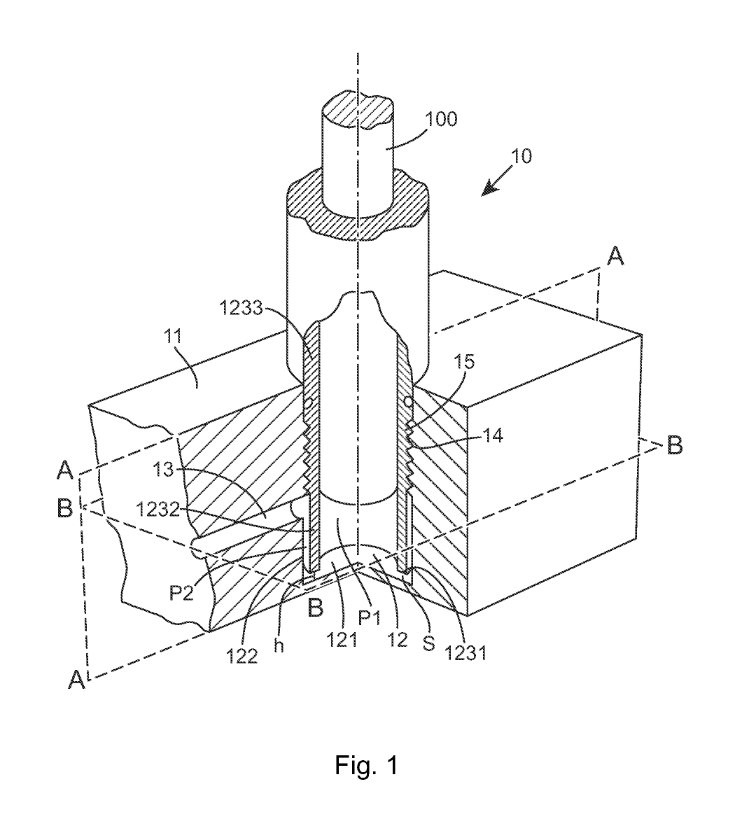

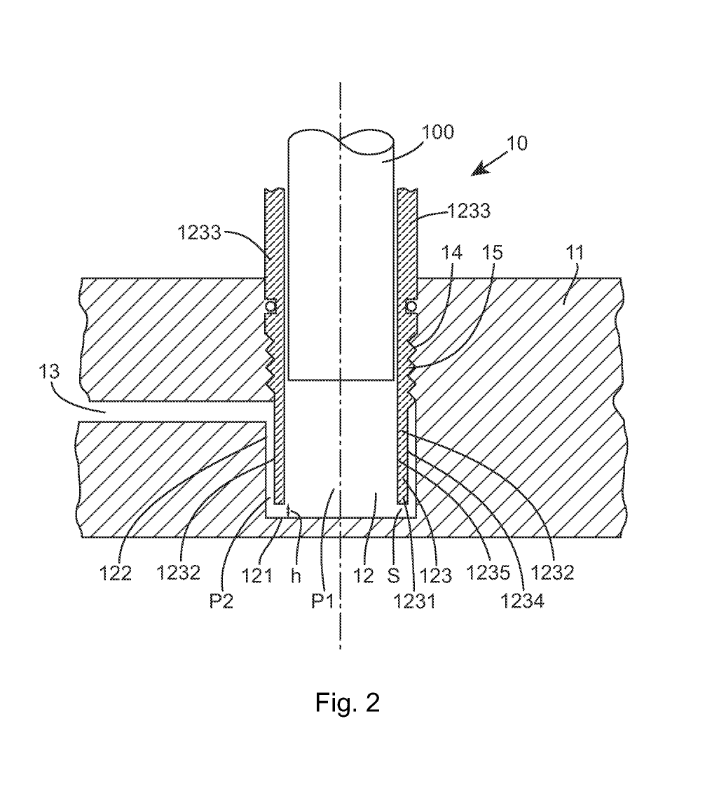

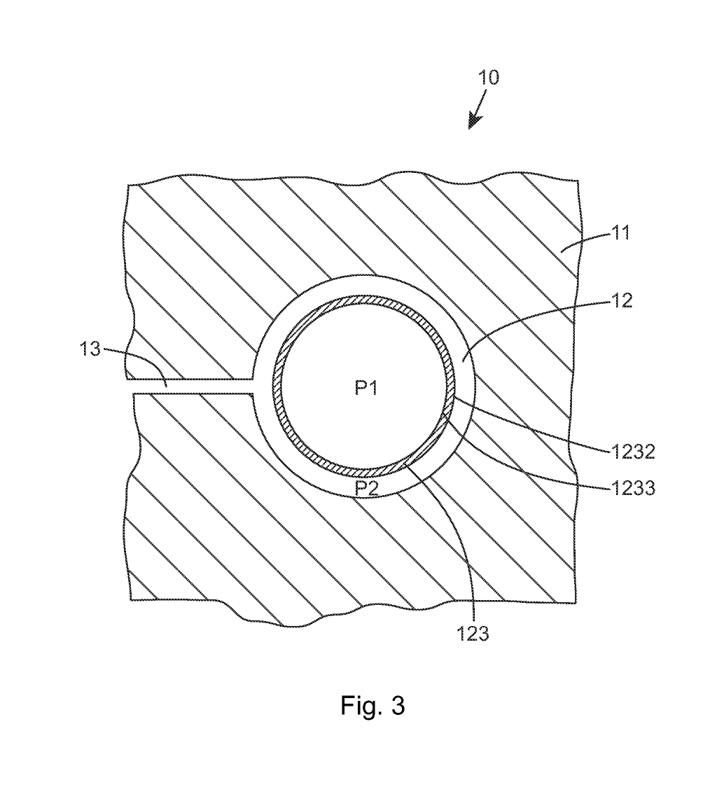

Referring to FIGS. 1 to 3 of the drawings, there is illustrated a hydraulic actuator 10 in accordance with one embodiment of the present invention. The actuator 10 comprises a housing 11, a chamber 12 disposed within the housing, and a fluid inlet 13 formed within the housing.

The chamber 12 comprises a base 121 and a tubular side wall 122 sealingly attached to the base 121 at the periphery thereof. The base 121 and tubular side wall 122 are formed integrally within the housing 11 by machining a cavity therein. This embodiment is simple and hence cost-effective to manufacture. In the illustrated embodiment, the tubular side wall 122 is circular in cross-section but other shapes of cross-section are also possible such as a square cross-section or an elliptical cross-section. The chamber 12 also comprises a sleeve 123 having an open end 1231 proximal to the base 121 and spaced apart therefrom to define a space S therebetween. The sleeve 123 is tubular with an interior radius that is uniform across its height. The sleeve 123 comprises a thin portion 1232 and a thicker portion 1233, an outer radius of the thicker portion 1232 being greater than an outer radius of the thin portion 1233. The sleeve abuts the housing 11 proximal to the thicker portion 1232 and is spatially separated from the housing 11 proximal to the thin portion 1231. In the illustrated embodiment the sleeve 123 is circular in cross-section and thus the radius of the thicker portion 1233 is greater than the radius of the thin portion 1232 in all circumferential directions. However, it will be appreciated that cross-section of the sleeve 123 may not be circular in shape, in which case only the radius in the direction of the fluid inlet 13 must be greater in the thicker portion 1233 than in the thin portion 1232. The thicker portion 1233 is disposed above the thin portion 1232 (maintaining the definition of the upwardly direction as the direction in which the chamber 12 extends from the base 11). In the illustrated embodiment, the lowermost point of the thicker portion 1233 is disposed immediately above the fluid inlet 123. The longitudinal axis of the sleeve 123 is parallel to the longitudinal axis of the tubular side wall 122 of the chamber 12.

The sleeve 123 is sealingly attached to the housing 11 by attachment means. The attachment means comprises a first threaded member 14 disposed on the housing 11 immediately above the fluid inlet 13 and a second threaded member 15 disposed on an exterior face 1234 of the sleeve and arranged for cooperation with the first threaded member 14. As such, the sleeve 123 may be manufactured separately from the housing 11 and subsequently sealingly attached to the housing 11.

The sleeve 123 partially divides the chamber into an inner portion P1 and a radially outer portion P2. The outer portion P2 is arranged to communicate high pressure fluid from the fluid inlet 13 to the inner portion P1 through the space S defined between the open end 1231 of the sleeve 123 and the base 121, whilst the inner portion P1 is adapted for receiving a piston 100 such that the piston 100 is slidably actuable in dependence on the high pressure fluid received from the outer portion P2.

The inner portion P1 is bounded at its upper end by a sealing engagement with the piston 100, at its lower end by the base 121, and is also bounded by an interior face 1235 of the sleeve 123. The uniform cross-section of the sleeve 123 ensures that the cross-section of the inner portion P1 is also uniform throughout its height. This enables slidable actuation of the piston 100 disposed therein, the piston 100 maintaining a sealing engagement with the interior face 1235 of the sleeve 123 throughout. In the illustrated embodiment, the inner portion P1 is circular in cross-section.

The outer portion P2 is bounded at its upper end by the attachment means (disposed at the transition between the thin portion 1232 and the thicker portion 1233 of the sleeve 123), at its lower end by the base 121, and is also bounded by the exterior face 1234 of the sleeve 123 and an interior face of the tubular side wall 122. As such, the outer portion P2 terminates above the fluid inlet 13 and is therefore truncated with respect to the inner portion P1. In the illustrated embodiment, the outer portion P2 is annular in cross-section.

The outer portion P2 is fluidly connected to the fluid inlet 13. It will be appreciated that the cross-sectional area of the flow path from the fluid inlet to the outer portion P2 is equal to the cross-sectional area of the fluid inlet 13, for example the product of the width of the inlet 13 and the height of the inlet 13.

The inner portion P1 is fluidly connected to the outer portion P2 by a flow path through the space S defined between the base 121 and the open end 1231 of the sleeve 123. The shape of the space S is dictated by the shape of the perimeter of the the sleeve 123 at its open end 1231, therefore in the illustrated embodiment the space S is circular in cross-section. However, it will be appreciated that other embodiments are possible in which the space S is for example arcuate or linear in cross-section. The cross-sectional area of the flow path through the space S is given by the product of the perimeter of the open end 1231 of the sleeve 123 and the height h of the open end 1231 of the sleeve 123 above the base 121. It is envisaged that the perimeter of the sleeve 123 at its open end 1231 is greater than the width of the fluid inlet 13; therefore the height h of the open end 1231 of the sleeve 123 above the base 121 may be significantly less than the height of the fluid inlet 13. As such, the closed height of the actuator 10 of the present invention is reduced in comparison to an actuator without the feature of a sleeve and with a fluid inlet that abuts the base of the chamber.

In use, a source of hydraulic fluid is connected to a distal end of the fluid inlet 13 and the piston 100 is disposed within the inner portion P1 of the chamber 12. The hydraulic fluid may be petroleum oil or other appropriate fluid. The source of hydraulic fluid may be a hydraulic pump, a second hydraulic actuator or any other device known in the art.

In order to actuate the piston 100 upwardly, high pressure fluid is delivered to the chamber 12 through the fluid inlet 13. Upon exiting the fluid inlet 13, the fluid initially enters the outer portion P2 of the chamber 12. In the illustrated embodiment the fluid inlet 13 is disposed at the top of the outer portion P2 therefore the fluid is prevented from flowing upwardly when it inters the outer portion P2. Accordingly, the fluid flows substantially downwardly, the flow path bounded by the exterior face 1234 of the sleeve 123 and the interior face of the tubular side wall 122. The fluid then passes from the outer portion P2 to the inner portion P1 through the space S defined between the open end 1231 of the sleeve 123 and the base 121. The inflow of fluid into the inner portion P1 causes the fluid level therein to rise. As the fluid level rises, the high pressure of the fluid exerts an upwardly directed force on a bottom face of the piston 100, causing it to move slidingly upwardly along the inner portion P1. The sealing engagement of the piston 100 with the interior face 1235 of the sleeve 123 ensures that the fluid does not travel upwardly around the piston 100 and thus the pressure exerted by the fluid acts to actuate the piston 100.

In order to actuate the piston 100 downwardly, fluid within the chamber 13 is drawn through the fluid inlet 13 by suction or the like. This reduces the fluid level in the inner portion P1 of the chamber 12, which enables the piston 100 to move downwardly by the action of gravity and by vacuum suction created as the high pressure fluid is drawn from the chamber 12.

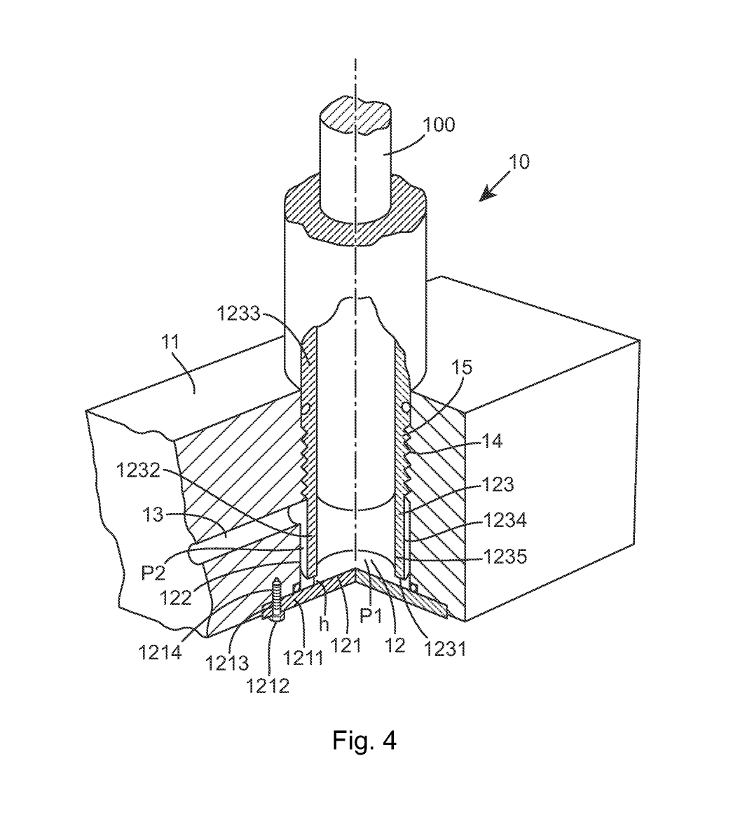

Referring to FIG. 4 of the drawings, there is illustrated a hydraulic actuator 10 in accordance with an alternative embodiment of the present invention. The hydraulic actuator 10 is similar to the actuator illustrated in FIGS. 1 to 3 of the drawings and like parts are given like reference numerals. The hydraulic actuator 10 illustrated in FIG. 4 differs from the hydraulic actuator illustrated in FIGS. 1 to 3 with regards the base 121 of the chamber 12. In this embodiment, the base 121 is formed from a plate 1211 that is distinct from the housing 11. As such, the base 121 may be formed of a different material to the housing 11. The plate 1211 from which the base 121 is formed extends further than the cross-sectional area of the chamber 12. The base 121 is removably coupled to the housing 11 by fastening means such as an externally threaded screw 1212 that is arranged to pass through an internally threaded aperture 1213 in the base 121 and an internally threaded cavity 1214 in the housing 11. The fastening means are spatially separated from the chamber 12 therefore do not interfere with the actuation of the piston 100 within the chamber 12. In the illustrated embodiment the plate 1211 is flat, but it will be appreciated that the plate 1211 may for example comprise protrusions or recesses to aid in fastening the plate 1211 to the housing. The base 121 sealingly engages with the tubular side wall 122 of the chamber 12 by means of an O-ring seal or other conventional sealing means.

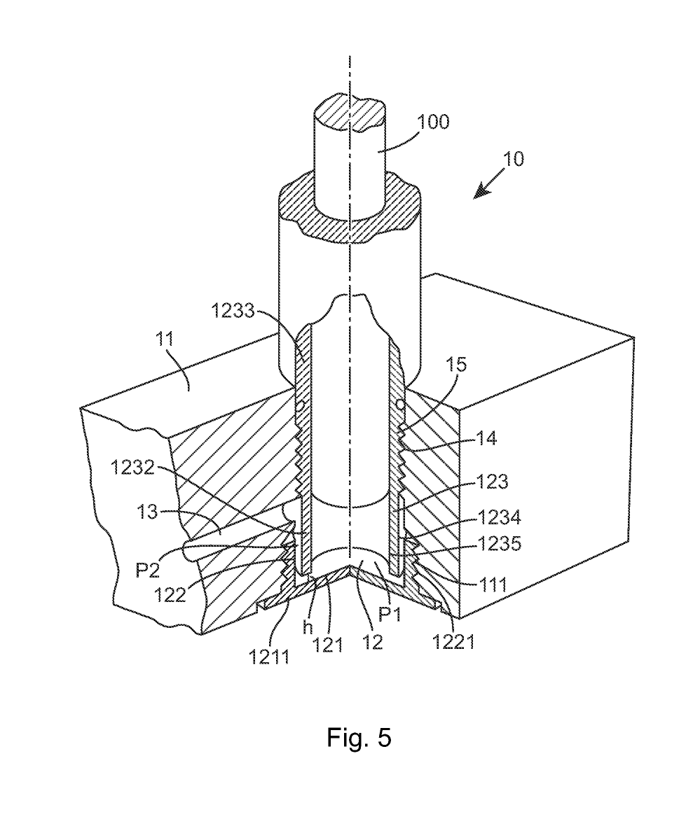

Referring to FIG. 5 of the drawings, there is illustrated a hydraulic actuator 10 in accordance with a second alternative embodiment of the present invention. The hydraulic actuator 10 is similar to the actuator illustrated in FIGS. 1 to 4 of the drawings and like parts are given like reference numerals. The hydraulic actuator 10 illustrated in FIG. 5 differs from the hydraulic actuator illustrated in FIGS. 1 to 3 with regards the base 121 and the tubular side wall 122 of the chamber 12. In this embodiment, the base 121 and tubular side wall are formed integrally within a base plate 1211 but are separate from the housing 11. The plane of the plate 1211 from which the base 121 and tubular side wall 122 are formed extends further than the cross-sectional area of the chamber 12. The base 121 is removably coupled to the housing 11 by fastening means such as an externally threaded screw 1221 integrally formed on an outer face of the tubular side wall 122 and arranged for cooperation with an internally threaded screw 111 formed integrally in the housing 11. The fastening means may alternatively or additionally comprise a screw (not shown) arranged to pass through an internally threaded aperture (not shown) in the base 121 and an internally threaded cavity (not shown) disposed in the housing 11.

In a third alternative embodiment (not shown) the actuator may be arranged for receiving a piston that is square in cross-section, in which case the tubular side wall (not shown) of the chamber (not shown) may be substantially rectangular, and the sleeve (not shown) may be substantially planar, so as to divide the rectangular chamber (not shown) into a square inner portion (not shown) and a rectangular outer portion (not shown). As such, the inner portion (not shown) is bounded partially by the tubular side wall (not shown) and partially by a first face of the sleeve (not shown); whilst the outer portion (not shown) is bounded partially by the tubular side wall (not shown) and partially by a second face of the sleeve (not shown). As with the first embodiment, the outer portion is arranged to communicate high pressure fluid from the fluid inlet to the inner portion through a space defined between the end of the sleeve and the base, and the inner portion being adapted to slidably receive a piston such that the piston is slidably actuable in dependence on the high pressure fluid received from the outer portion.

It will be appreciated that whilst the description of the hydraulic actuator 10 has thus far focused on its use as an output actuator, it may equally function as an input actuator i.e. the piston 100 may be manually actuated in order to control the fluid that passes into and out of the fluid inlet 13. This fluid may then be communicated to a separate output actuator, which may or may not be an actuator in accordance with the present invention.

1. A hydraulic actuator comprising a housing, a chamber disposed within the housing, and a fluid inlet formed within the housing arranged for communicating hydraulic fluid to the chamber,
wherein the chamber comprises a base, a tubular side wall and a sleeve having an open end proximal to the base and spaced apart therefrom, the sleeve being arranged to divide the chamber into an inner portion and a radially outer portion, the outer portion being arranged to communicate high pressure fluid from the fluid inlet to the inner portion through a space defined between the end of the sleeve and the base, and the inner portion being adapted to receive a piston such that the piston is slidably actuable in dependence on the high pressure fluid received from the outer portion.

2. A hydraulic actuator according to claim 1, wherein the open end of the sleeve is disposed longitudinally intermediate the fluid inlet and the base of the chamber.

3. A hydraulic actuator according to claim 1, wherein an outer face of the sleeve abuts the housing above the fluid inlet and is spatially separated from the housing below the fluid inlet.

4. A hydraulic actuator according to claim 1, wherein an exterior face of the sleeve is sealingly attached to the housing by attachment means.

5. A hydraulic actuator according to claim 4, wherein the attachment means are disposed immediately above the fluid inlet.

6. A hydraulic actuator according to claim 4, wherein the attachment means comprises a first threaded member disposed on the housing and a second threaded member disposed on the exterior face of the sleeve, the second threaded member being arranged for cooperation with the first threaded member.

7. A hydraulic actuator according to claim 1, wherein the sleeve is tubular.

8. A hydraulic actuator according to claim 1, wherein a longitudinal axis of the sleeve is substantially parallel to a longitudinal axis of the tubular side wall.

9. A hydraulic actuator according to claim 8 wherein the sleeve is concentric with the tubular side wall.

10. A hydraulic actuator according to claim 1, wherein the inner portion is substantially circular in cross-section.

11. A hydraulic actuator according to claim 1, wherein the outer portion is substantially annular in cross-section.

12. A hydraulic actuator according to claim 1, wherein the inner portion extends upwardly further from the base of the chamber than the outer portion.

13. A hydraulic actuator according to claim 1, wherein the base of the chamber is formed integrally within the housing.

14. A hydraulic actuator according to claim 1, wherein the tubular side wall of the chamber is formed integrally within the housing.
